(19) United States
(12) Patent Application Publication
(10) Pub. No.: US 2002/0165875 A1
(43) Pub. Date: Nov. 7, 2002

(54) Data capture and management system

(76) Inventor: Patrick A. Verta, San Francisco, CA (US)

Correspondence Address: MAREK ALBOSZTA, LUMEN INTELLECTUAL PROPERTY SERVICES, 45 CABOT AVENUE, SUITE 110, SANTA CLARA, CA, 95051, US

(21) Appl. No.: 09/976,848

(22) Filed: Oct. 12, 2001

Related U.S. Application Data
(60) Provisional application No. 60/288,620, filed on May 4, 2001.

(51) Int. Cl. G06F 15/00

(52) U.S. Cl. 707/503

(57) ABSTRACT

A data capture and management system is provided with a plurality of tabular forms that represents a multidimensional database system. Each tabular form contains a plurality of cells, wherein at least one cell of interest can be selected that corresponds to another tabular form. At least two different means of activating a cell of interest are used to display data from the tabular form that corresponds to the cell of interest. The data from the corresponding tabular form could be displayed partially as a data sheet or displayed entirely as a corresponding tabular form. A plurality of descriptors for a cell of interest provide status information of the data contained in a corresponding tabular form that enable one to quickly review and interpret large data sets.

### CROSS-REFERENCE TO RELATED APPLICATIONS

This application is cross-referenced to and claims priority from U.S. Provisional application 60/288,620 filed May 04, 2001, which is hereby incorporated by reference.

### FIELD OF THE INVENTION

This invention relates generally to computer software and the Internet. More particularly, the present invention relates to a data capture and management system.

### BACKGROUND

Data management has become not only more involved due to higher data volumes, but also more important in research and development due to a shortened time to market in increasingly demanding and more global markets. This is particularly true in the age of faster computers and the Internet where it has become easier to acquire, exchange and process data. For example, about forty percent of the research and development expenses of pharmaceutical companies is used for clinical trial data capture and management. Clinical trials usually generate a significant amount of data that requires the effort of a large team of people including physicians, clinical data managers, data entry personnel, programmers, and statisticians. Each member of the team performs a specific function vital to the quality of the end database. A system that enables one to concurrently access and process data at the several stages of the database lifecycle enhances the overall work process and accelerates database development.

The use of off-the-shelve database packages will probably be capable of processing all the data captured in, for instance, a clinical trial, product database, or a weather forecast system. However, these packages usually have difficulty being accepted by the various different types of users. One of the reasons is that these packages become too involved and complicated to interact with. It is not uncommon for users to loose track of the status of entered data. In addition, current database management systems commonly lack flexibility, scalability, and performance in order to connect to its users. Therefore, to get a higher acceptance rate by its users and become a more useful tool, there is a strong demand to develop future data capture and management systems that include better ways to organize data as well as novel techniques to quickly review the status of entered data.

Accordingly, there is a need to develop a more practical and useful data capture and management system that facilitates user cooperation and global operability.

### SUMMARY OF THE INVENTION

The present invention provides a data capture and management system that is accessible by a computer or the Internet. The system tangibly embodies a program of instructions that are executable by a computer to perform method steps for data capture and management. In accordance with exemplary embodiments, the present invention includes a plurality of tabular forms, thereby representing a multi-dimensional database system. The present invention could include just one tabular form, however, most applications require several corresponding tabular forms. Each tabular form contains data in a plurality of cells. Other types of data representations could also be included. Each cell could correspond to a corresponding tabular form. The data between corresponding tabular forms could be displayed by activating a cell of interest in a tabular form of interest. A particular cell of interest is activated by at least two different means of activating. For example, a first means and a second means of activating a cell of interest which need to distinguishable from each other. Means of activating a cell are, for instance, but not limited to, a click, a double-click, roll-over, or other means of activating a cell. The first means of activating a cell of interest in a tabular form of interest is used to display, for instance, a data sheet. Other types of data representations could also be used. The data sheet displays, for instance, a data summary or a selection of data that corresponds to the data from a corresponding tabular form. The corresponding tabular form is part of the plurality of tabular forms and is associated to the cell of interest. The second means of activating a cell of interest in a tabular form of interest is used to display, for instance, the corresponding tabular form.

In addition, the present invention provides various ways of reviewing the status of the entered data. For instance, it might be important to know that, after data has been entered in, for instance, a tabular form of interest, the form could still require some additional data to be filled out in some of the cells. Other examples that might be of interest for review are, for example, but not limited to, the information that a particular tabular form needs to be verified, statistical parameters need to be calculated, the form contains erroneous data, or the form contains data exceeding predefined boundaries. The different ways of reviewing the status of the data in a form or data sheet is accomplished by different descriptors, which is accomplished by providing a cell with a descriptor. Examples of descriptors are, for instance, but not limited to, a plurality of signs, a plurality of colors, a plurality of tags, or a plurality of statistical parameters. In case of colors, different color codes are used to indicate the status of data of a tabular form, which is indicated by that color of a cell.

The data capture and management system could be used on a single computer, but could also be part of an internet-based network that contains a central hub and one or more agents or computers connected to the central hub to perform at least one data capture and management operation. In this case, the system also provides a web-browser for online communication between a user using one or more agents and the central hub. Besides an online connection, the system, could also be used offline in which a local web-browser is provided for offline communication between a user using one or more agents and a local server. The system also provides mechanisms for synchronizing at least one data capture and management operation between the local server and the central hub.

In addition, the system includes a manager with a plurality of tools to manage at least one data capture and management operation. The system also includes different mechanisms to display information of at least one data capture and management operation as well as different mechanisms to manipulate data in the plurality of cells. For instance, these manipulation mechanisms include, but are not limited to, the basic computer data operations such as copy, cut, paste, edit, undo, drag, or delete as well as mathematical operations. In addition, data could be manipulated by the use of, for example, but not limited to, radio buttons, sliders, data menus, click boxes, or the like. Manipulation of data is possible at the tabular form level as well as the data sheet level of the system

In view of that which is stated above, it is the objective of the present invention to provide a data capture and management system with a plurality of tabular forms that represents a multi-dimensional database system.

It is another objective of the present invention to provide a data capture and management system in which each tabular form contains a plurality of cells, wherein at least one cell of interests can be selected that corresponds to another tabular form.

It is yet another objective of the present invention to provide a data capture and management system that contains at least two different means of activating a cell of interest to display data from the tabular form that corresponds to the cell of interest. The data from the corresponding tabular form could be displayed partially as a data sheet or displayed entirely as a corresponding tabular form.

It is still another objective of the present invention to provide a plurality of descriptors for a cell of interest to provide status information of the data contained in a corresponding tabular form.

It is still another objective of the present invention to provide a flexible data capture and management system in which data can be quickly interpreted and manipulated.

It is another objective of the present invention to integrate the data capture and management system in a local as well as a global network connected to a central hub, wherein the system could be used on different computers and act as different agents that interact with the central hub.

The advantage of the present invention over the prior art is that the system enables one to capture and manage large amounts of multidimensional data, such as, but not limited to, data obtained in clinical trials, by incorporating mechanisms for easy access and review at the different levels of the multidimensional database. Another advantage is that the present invention uses different descriptors that enable one to quickly review and interpret large data sets.

### BRIEF DESCRIPTION OF THE FIGURES

The objectives and advantages of the present invention will be understood by reading the following detailed description in conjunction with the drawings, in which:

FIG. 1 illustrates the general concept of a plurality of tabular forms with a plurality of cells according to the present invention;

FIG. 2 illustrates a data capture and management system according to the present invention;

FIG. 3 illustrates a tabular form with a data sheet according to the present invention;

FIG. 4 illustrates a corresponding tabular form according to the present invention;

FIG. 5 illustrates a corresponding tabular form with a data sheet according to the present invention;

FIG. 6 illustrates a corresponding tabular form of descriptor data including a data sheet according to the present invention;

FIG. 7 illustrates a corresponding tabular form with a data sheet that allows data manipulation according to the present invention; and

FIG. 8 illustrates an Internet setup for utilizing the data capture and management system according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

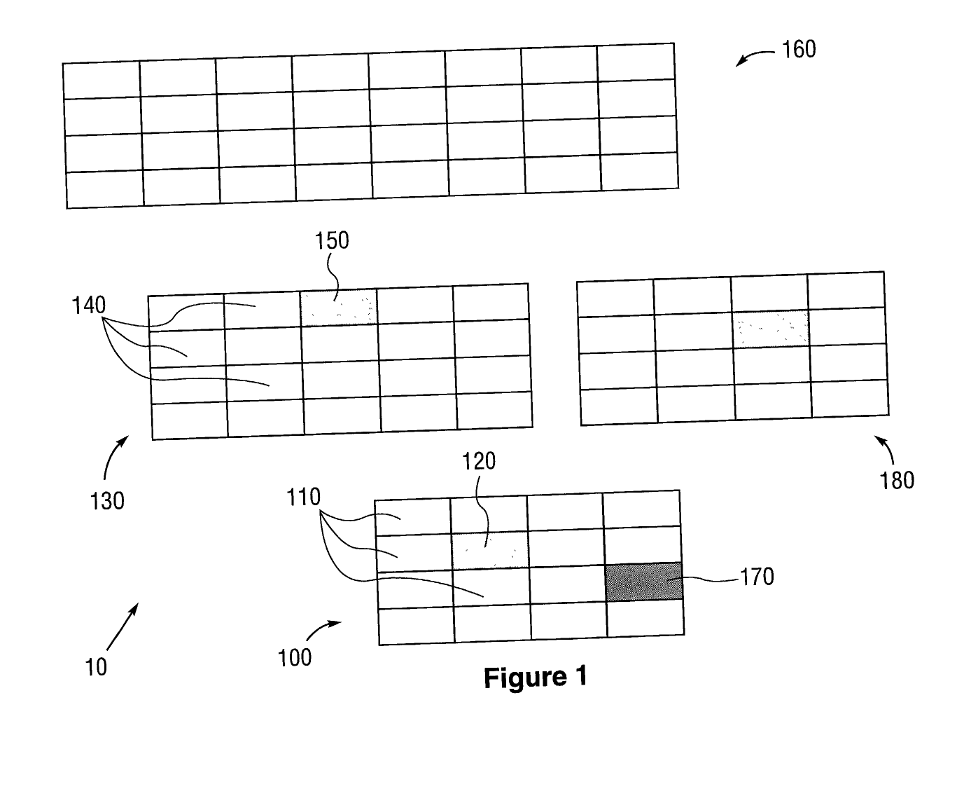

The present invention provides a data capture and management system that is accessible by a computer or the Internet. The system tangibly embodies a program of instructions that are executable by a computer to perform method steps for data capture and management. In accordance with several exemplary embodiments, the present invention includes a plurality of tabular forms and represents a multi-dimensional database system. FIG. 1 shows the general concept of a plurality of tabular forms 10. Each tabular form in 10, e.g. 100, 130, 160, and 180, contains a plurality of cells. For instance, tabular form 100 contained cells 110 and tabular form 130 contained cells 140. The present invention is not limited to a data representation in cells 110, whereas other forms of data representation could also be used. Cells 110 and 140, for example, could represent data in terms of number, letters, images, and the like. A cell of interest 120 in a tabular form 100 could correspond to a corresponding tabular form 130 and is a selected cell by the user from cells 110. The corresponding tabular form 130 also contains a plurality of cells 140. The present invention could include just one tabular form, however, most applications require several corresponding tabular forms, thereby creating a complex and multidimensional data capture and management system. The idea is that a cell of interest 120 represents a corresponding tabular form 130, as is discussed in more detail below. In the most extensive case, all cells 110 of tabular form 100 could represent a corresponding form, thereby creating a complex and multi-dimensional system. For instance, a clinical trial database is such a complex and multi-dimensional system, wherein each cell 110 could represent a particular client or patient and test date. Each cell 110 is then a cell of interest like cell 130 and will then correspond to a corresponding tabular form such as 130 that corresponds to 120. A corresponding tabular form 130 could then contain, for instance, all the data for a particular client or patient. Another example is that corresponding tabular form 130 could contain specific medical data of that particular client or patient. The present invention is not limited to a clinical trial database systems, which is presented as an exemplary embodiment, as it could also be used for product or inventory data management, weather database systems, pharmaceutical drug database systems, and the like. The present invention is also not limited to the number of cells 110 that correspond to a corresponding tabular form 130. A single cell 110 or a plurality of cells 110 could be associated to subsequent or corresponding tabular forms. For example, cell 170 could be selected as a cell to correspond to tabular form 180. Furthermore, the corresponding tabular form 130 could also contain a selected cell of interest 150 that corresponds to yet another level with a corresponding form 160. Thereby, the system encompasses a cascading mechanism of tabular forms at different levels. The general idea is that this system enables one to manage and capture data from a global to a more specific perspective and level of detail, wherein the first tabular form 100 represents the subsequent and corresponding tabular form 130 in a global sense by just one cell, for instance 120, whereas the corresponding tabular form 130 provides more detail to the user in its plurality of cells 140.

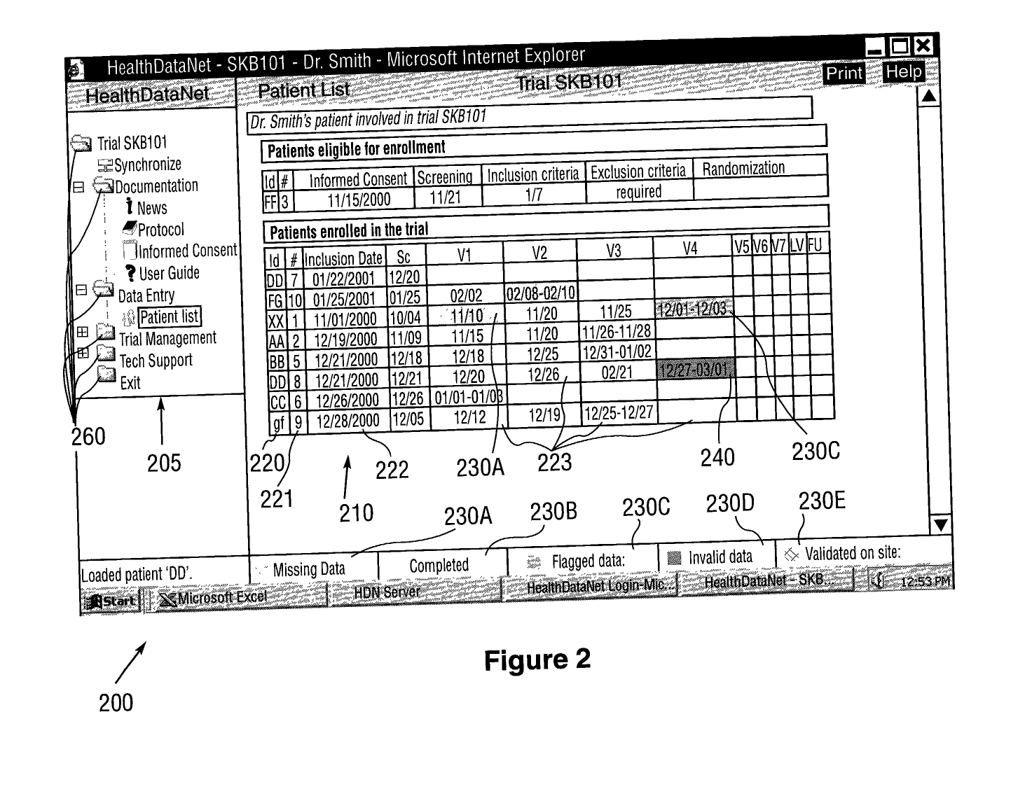

FIG. 2 shows an exemplary embodiment of a clinical trial data capture and management system 200. Tabular form 210 contains a plurality of cells. In this particular example, the cells are used for different purposes such as patient ID 220, patient number 221, patient inclusion data 222, or clinical trial test data 223. As one skilled in the art might readily acknowledge, many different types of data could be represented in each cell in tabular form 210 as is discussed below in more detail.

The present invention provides various ways of reviewing the status of the entered data in a tabular form of interest. For instance, it might be important to know that after data has been entered in, for instance, a tabular form 210, the form could still require some additional data to be filled out in some cells. Referring back to FIG. 1, it is important to realize that the entered data could either be done at the first level, which is tabular form 100, or at the subsequent/corresponding level, which is for instance tabular form 130, 160 or 180. Other examples that might be of interest for review are, for example, but not limited to, the information that a particular tabular form needs to be verified, statistical parameters need to be calculated, the form contains erroneous data, or the form contains data exceeding predefined boundaries. Referring back to FIG. 2, the different ways of reviewing the status of the data in form 210 is accomplished by different descriptors, for example, and not limited to, 230A, 230B, 230C 230D, and 230E, which is accomplished by providing a cell of interest 240 with a descriptor 230D. As shown in the particular example of FIG. 2, the information given by a descriptor could be “missing data” 230A, “completed” 230B, “flagged data” 230C, invalid data” 230D, and “validated on site” 230E. Examples of descriptors are, for instance, but not limited to, a plurality of signs, a plurality of colors, a plurality of tags, or a plurality of statistical parameters. In case of colors, different color codes are used to indicate the status of data of a tabular form, which is indicated by that color of a cell.

As shown in FIG. 2, the data capture and management system 200 includes a manager 250 with a plurality of tools 260 to manage at least one data capture and management operation. Examples of tools 260 are, for instance, but not limited to, different folders with standard computer software means to manage at least one database, a user guide, technical support, or the like. The system also includes different tools 260 to display information of at least one data capture and management operation. In addition, as is discussed below, the manager 250 also contains tools 260 to utilize the data capture and management system 200 on either a single computer, as well as part of an internet-based network.

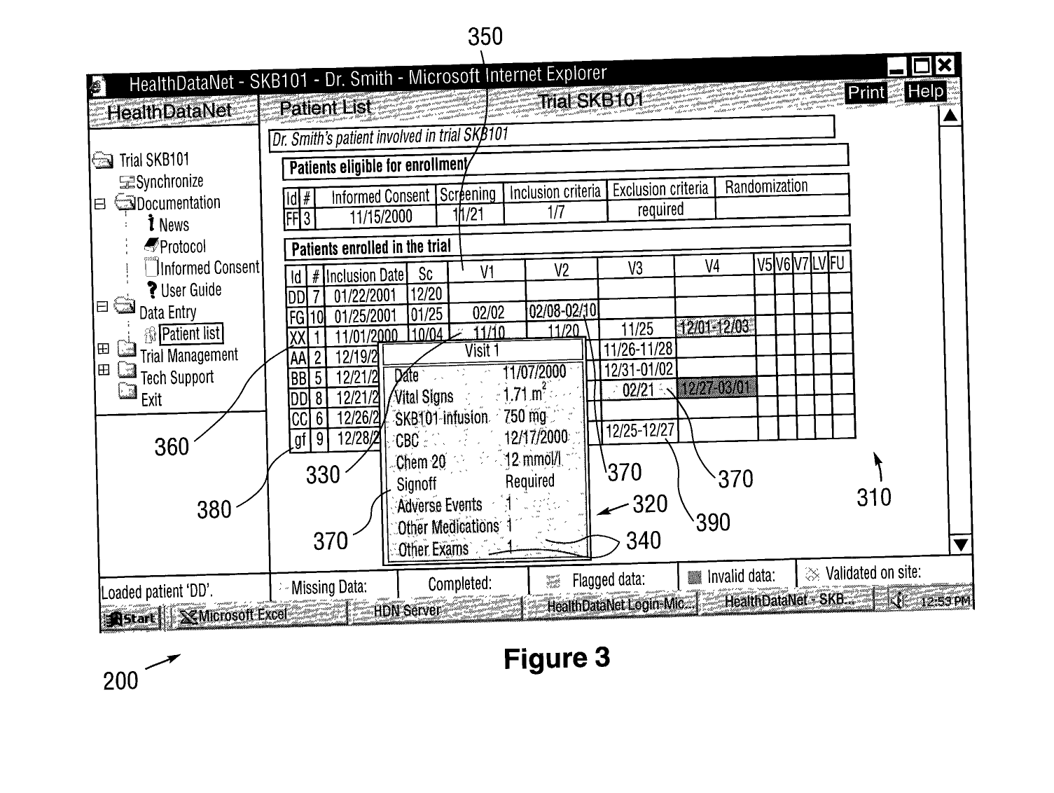

As discussed above with respect to FIG. 1, the data between corresponding tabular forms could be viewed by activating a cell of interest in a tabular form of interest. In fact, a particular cell of interest could be activated by at least two different means of activating. For example, a first means and a second means of activating a cell of interest. The first means of activating a cell is, for instance, but not limited to, a click, a double-click, roll-over, or other means of activating a cell. The activation could be accomplished by a computer mouse, by a touch to a screen, a remote device, or the like. FIG. 3 shows tabular form 310 which is identical to tabular form 210 in FIG. 2. However, tabular form 310 also shows data sheet 320. Data sheet 320 is displayed by a first means of activating a cell of interest 330 in a tabular form of interest 310, such as, for instance, a roll-over. The present invention is not limited to the example of a data sheet 320, since other types of data representations could also be used, such as, for instance, images, buttons, hyperlinks, or the like. The data sheet 320 displays, for instance, a data summary or a selection of data that corresponds to the data from a corresponding tabular form. In this particular embodiment referring to a clinical trial database, cells 340 in data sheet 320 could, for instance, represent and summarize specific data related to visit 1 350 of patient 360. The tabular form 310 as well as the data sheet 320 could both contain different descriptors 370 as discussed above to enable a user to quickly review the status of the entered data.

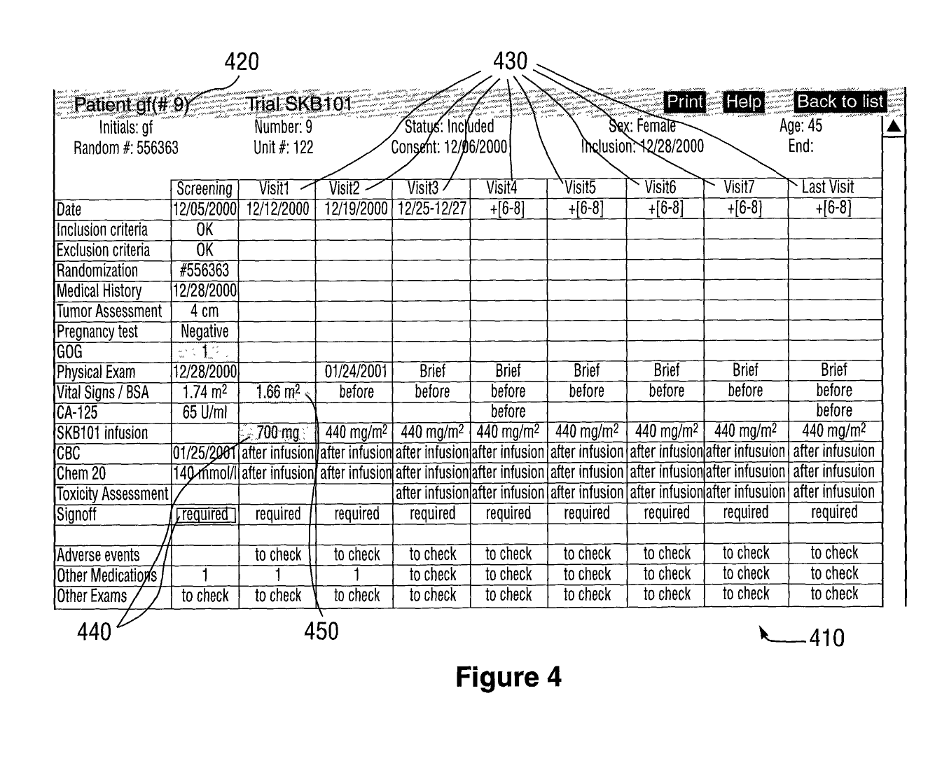

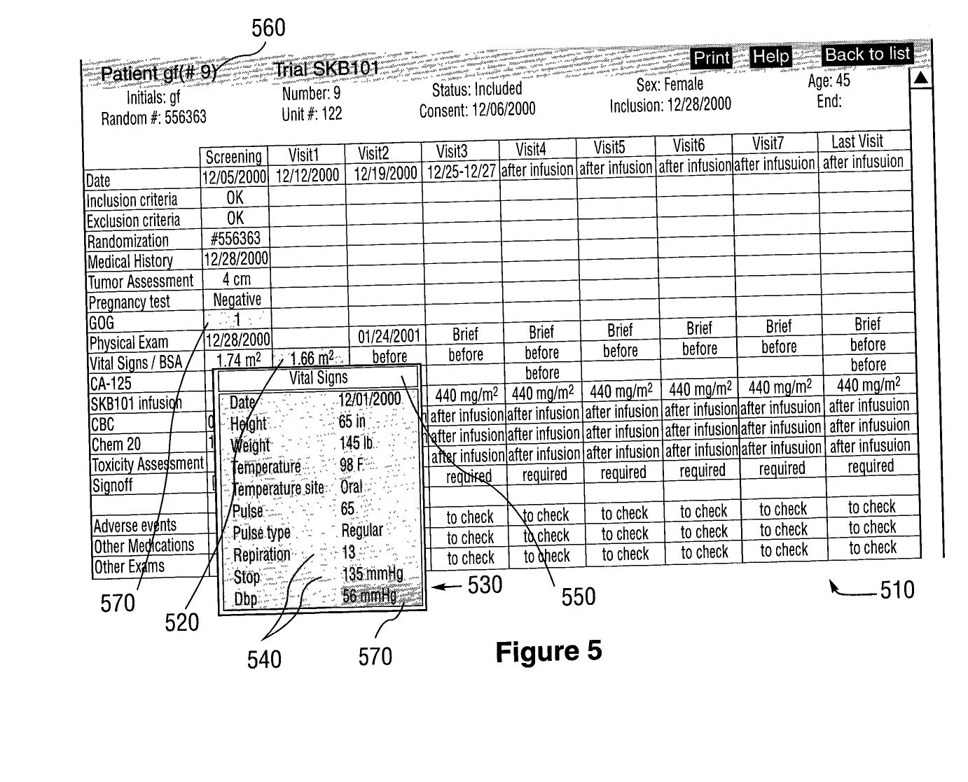

A second means of activating a cell of interest in a tabular form of interest is used to display, for instance, the corresponding tabular form. The second means of activating a cell is selected from the same group, but not limited to, as the first means of activating the cell of interest with the requirement that first and second means are different and distinguishable. As an exemplary embodiment, the same cell 330 could be activated by a second means, such as a click, to display the corresponding tabular form. As an exemplary embodiment, as shown in FIG. 3, a cell of interest 390 for patient 380 is selected to display a corresponding tabular form 410 as shown in FIG. 4. The corresponding tabular form 410 contains more detailed data then the tabular form 310. According to the specific embodiment of a clinical trial database, corresponding tabular form 410 contains data for patient 420 (same patient as 380 in FIG. 3) specific to different visits or tests 430. Again, the tabular form 410 could contain different descriptors 440, as discussed above, to enable a user to quickly review the status of the entered data. As mentioned above, in each tabular form, a cell of interest could be selected and activated by a first or second means. Therefore, in corresponding tabular form 410, cell of interest 450 could be selected and activated to display either a subsequent/corresponding tabular form or a data sheet. FIG. 5 shows the exemplary embodiment wherein cell of interest 520 in corresponding tabular form 510 is activated. Note that cell of interest 520 in corresponding tabular form 510 is the same as cell of interest 450 in corresponding tabular form 410 in FIG. 4.

In addition to a first and a second means of activating a cell of interest, it might in some cases or applications be necessary to provide additional means, e.g. a third means, of activating a cell of interest. In other words, the present invention also includes one or more additional means of activating a cell of interest. The important aspect to consider is that the different means of activating a cell of interest should be distinguishable from each other, as discussed above.

The data sheet 530 displays, for instance, a data summary or a selection of data that corresponds to the data from a subsequent/corresponding tabular form. In this particular embodiment referring to a clinical trial database, cells 540 of data sheet 530 could, for instance, represent and summarize specific data related to vital signs 550 of patient 560. The tabular form 510 as well as the data sheet 530 could both contain different descriptors 570, as discussed above, to enable a user to quickly review the status of the entered data.

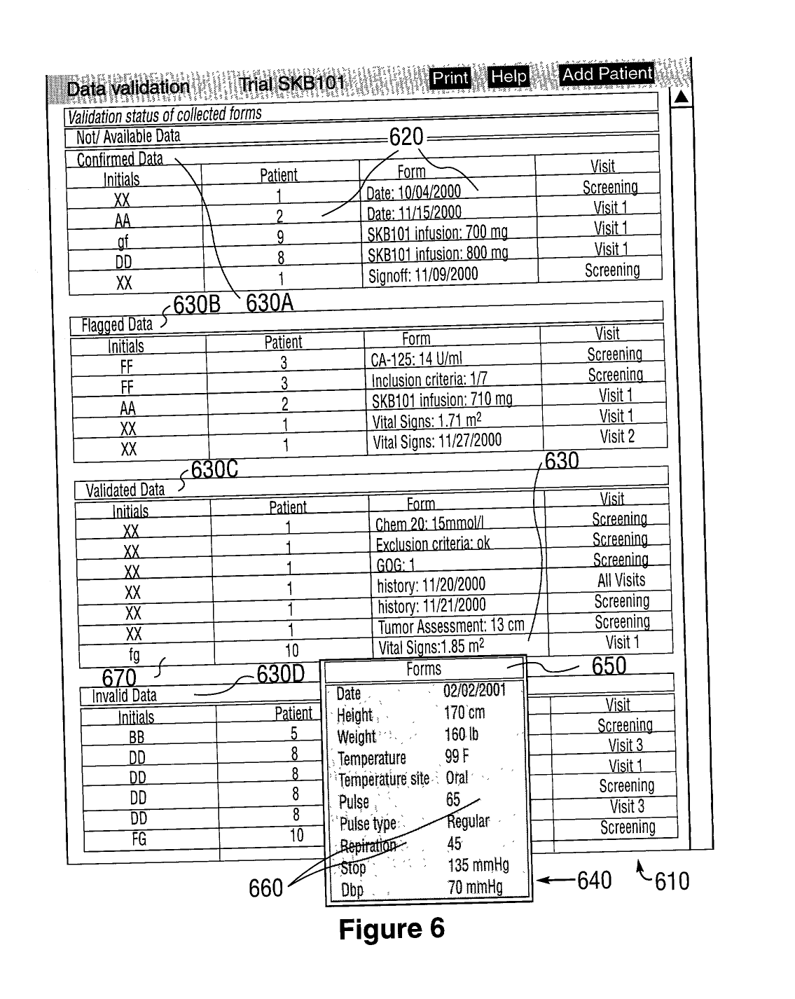

FIG. 6 is yet another example of an embodiment on how tabular forms and data sheets could interact. FIG. 6 shows tabular form 610, which classifies descriptor data from a plurality of different tabular forms in cells 620. The exemplary embodiment shows, for instance, but not limited to, a variety of different clusters of cells according to “confirmed data” 630A, “flagged data” 630B, “validated data” 630C, and “invalid data” 630D. Again, cells 620 in tabular form 610 could be selected, for example, cell 630 could be selected to display data sheet 640. In this particular example, data sheet 640 is a form 650 containing cells 660 to display general information about a patient 670 that corresponds to the cell of interest 630. Again, the tabular form 610, as well as the data sheet 640, could both contain different descriptors, as discussed above, to enable a user to quickly review the status of the entered data.

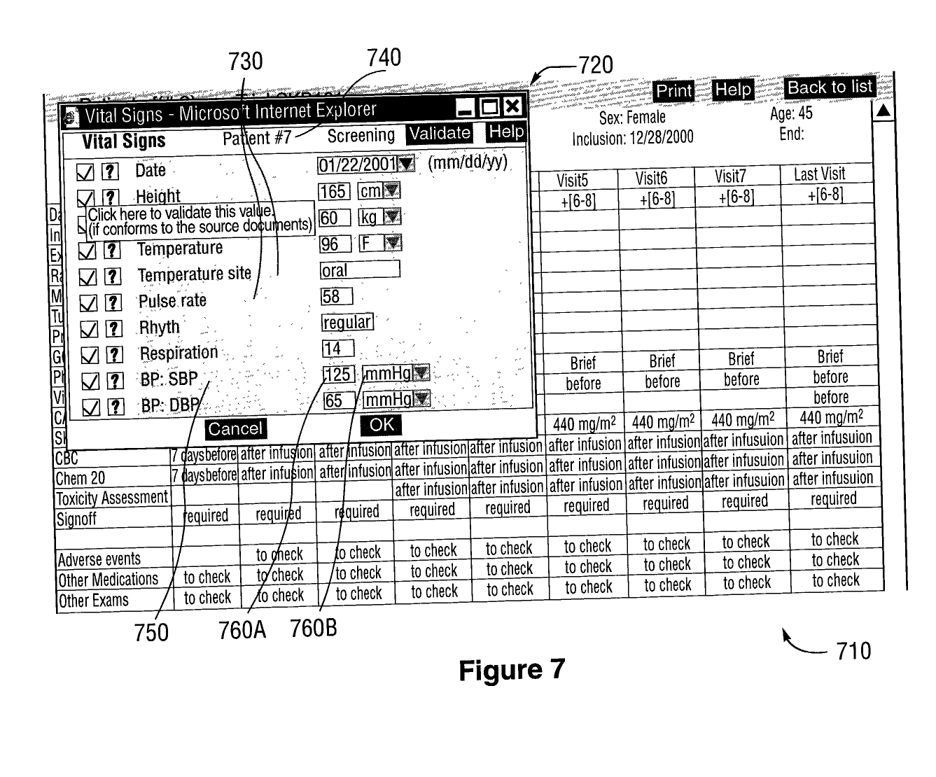

The data capture and management system of the present invention also includes different mechanisms to manipulate data in each of the plurality of cells. For instance, these manipulation mechanisms include, but are not limited to, the basic computer data operations such as copy, cut, paste, edit, undo, drag, or delete, as well as mathematical operations. Such operations are utilized at the tabular form level as well as the data sheet level of the system. FIG. 7 shows an exemplary embodiment in which data could be entered in data sheet 720 in tabular form 710. In the exemplary embodiment of a clinical trial, FIG. 7 shows a data sheet 720 with a variety of vital signs 730 of a patient 740. For instance, cell 750 requests a systolic blood pressure, for which the value could be entered in 760A and the units in 760B. As one skilled in the art might readily acknowledge, a wide variety of other techniques of entering data, rather than typing, could be employed, including, but not limited to, predefined radio buttons, sliders, menus, or equivalents thereof. In addition, the embodiment of a clinical trial is presented for exemplary purposes only and the present invention is not limited to clinical data as discussed above in which it could used also encompass product or inventory data, weather data, pharmaceutical drug data, and the like.

Furthermore, various types of mathematical operations could be carried out before data is displayed in a cell. It might, for instance, be important to convert data to a different unit (e.g. miles to km, cm to inches), change currency (dollars to French francs), perform a calculation based on a model or set of equations, or equivalents thereof. These mathematical operations are not limited to the level of tabular forms or whether the data concerns a data sheet of tabular form. An example of a calculation related to clinical trials is, for instance, but not limited to, the calculation of body surface area from height and weight. As one skilled in the art might readily appreciate, many different types of calculations can be included.

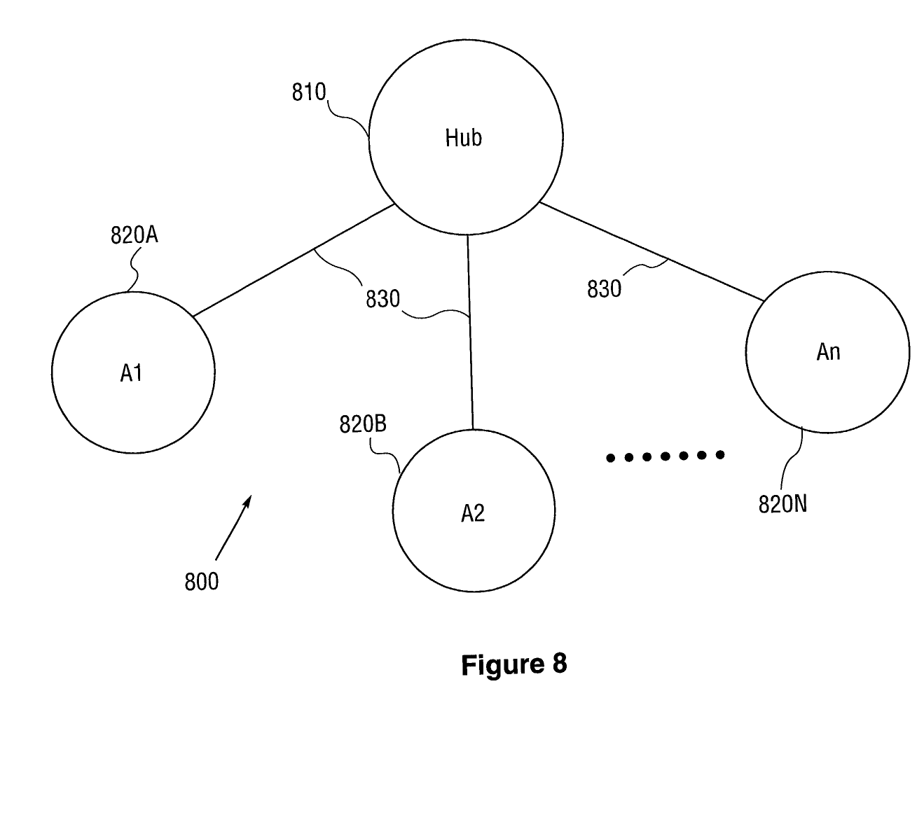

In addition, as is mentioned above, manager 250 in FIG. 2 also contains tools 260 to utilize the data capture and management system 200 on either a single computer 820A, now referring to FIG. 8 , as well as part of an internet-based network 800 that contains a central hub 810 and one or more agents or computers (820A, 820B . . . 820N) connected to central hub 810 to perform at least one data capture and management operation. In this case, the system also provides a web-browser for online communication 830 between a user using one or more agents 820A, 820B . . . 820N and the central hub 810. Online communication is, for instance, provided through a standard Web browser using an Internet service provider, an Intranet network system, or equivalents thereof. Besides an online connection, the system, could also be used offline in which a local web-browser is provided for offline communication between a user using one or more agents 820A, 820B . . . 820N and a local server stored on each of the agents 820A, 820B . . . 820N. Examples of a local web-browser are, for instance, a Local Area Network (LAN), a local server running on user's computer, or equivalents thereof. The system also provides mechanisms for synchronizing at least one data capture and management operation between the local server and the central hub. Synchronization is important when more than one user operates on the same database.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents

What is claimed is:

1. A program storage device accessible by a computer, tangibly embodying a program of instructions executable by said computer to perform method steps for data capture and management, said methods steps comprising:
(a) providing a plurality of tabular forms, wherein each of said tabular forms contains data in a plurality of cells;
(b) providing a first means of activating a cell of interest of said plurality of cells in a tabular form of interest of said plurality of tabular forms to display a data sheet with corresponding data from a corresponding tabular form of said plurality of tabular forms; and
(c) providing a second means of activating said cell of interest of said plurality of cells in said tabular form of interest of said plurality of tabular forms to display said corresponding tabular form.

2. The device as set forth in claim 1, wherein said method steps further comprise the step of providing in said cell a plurality of descriptors.

3. The device as set forth in claim 2, wherein said plurality of descriptors comprises a plurality of signs.

4. The device as set forth in claim 2, wherein said plurality of descriptors comprises a plurality of colors.

5. The device as set forth in claim 2, wherein said plurality of descriptors comprises a plurality of tags.

6. The device as set forth in claim 2, wherein said plurality of descriptors comprises a plurality of statistical parameters.

7. The device as set forth in claim 1, wherein said method steps further comprise the step of providing a manager with a plurality of tools to manage at least one data capture and management operation.

8. The device of claim 7, wherein said method steps further comprise the step of providing means to display information of said at least one data capture and management operation.

9. The device as set forth in claim 1, wherein said method steps further comprise the step of providing means to manipulate said data in said plurality of cells.

10. The device as set forth in claim 9, wherein said step of providing means to manipulate said data comprises means to copy, cut, paste, edit, undo, drag, or delete.

11. The device as set forth in claim 1, wherein said method steps further comprise the step of providing means to manipulate said corresponding data in said data sheet.

12. The device as set forth in claim 11, wherein said step of providing means to manipulate said data comprises means to copy, cut, paste, edit, undo, drag, or delete.

13. The device as set forth in claim 11, wherein said step of providing means to manipulate said data comprises means to use radio buttons, sliders, data menus, or click boxes.

14. The device as set forth in claim 1, wherein said method steps further comprise the step of providing one or more additional means of activating said cell of interest.

15. The device as set forth in claim 1, wherein said method steps further comprise means to calculate said data.

16. A method of using a database for clinical trial data capture and management, comprising the steps of:
(a) providing a plurality of tabular forms wherein each of said tabular forms contains data in a plurality of cells;
(b) providing a first means of activating a cell of interest of said plurality of cells in a tabular form of interest of said plurality of tabular forms to display a data sheet with corresponding data from a corresponding tabular form of said plurality of tabular forms; and
(c) providing a second means of activating said cell of said plurality of cells in said tabular form of said plurality of tabular forms to display said corresponding tabular form.

17. The method as set forth in claim 16, further comprising the step of providing in said cell a plurality of descriptors.

18. The method as set forth in claim 17, wherein said plurality of descriptors comprises a plurality of signs.

19. The method as set forth in claim 17, wherein said plurality of descriptors comprises a plurality of colors.

20. The method as set forth in claim 17, wherein said plurality of descriptors comprises a plurality of tags.

21. The method as set forth in claim 17, wherein said plurality of descriptors comprises a plurality of statistical parameters.

22. The methods as set forth in claim 16, further comprising the step of providing a manager with a plurality of tools to manage at least one data capture and management operation.

23. The method of claim 22, further comprising the step of providing means to display information of said at least one data capture and management operation.

24. The method as set forth in claim 16, further comprising the step of providing means to manipulate said data in said plurality of cells.

25. The method as set forth in claim 24, wherein said step of providing means to manipulate said data comprises means to copy, cut, paste, edit, undo, drag, or delete.

26. The method as set forth in claim 16, further comprising the step of providing means to manipulate said corresponding data in said data sheet.

27. The method as set forth in claim 26, wherein said step of providing means to manipulate said data comprises means to copy, cut, paste, edit, undo, drag, or delete.

28. The device as set forth in claim 26, wherein said step of providing means to manipulate said data comprises means to use radio buttons, sliders, data menus, or click boxes.

29. The device as set forth in claim 16, further comprising the step of providing means to calculate said data.

30. The device as set forth in claim 16, further comprising the step of providing one or more additional means of activating said cell of interest.
